(19) United States
(12) Patent Application Publication
(10) Pub. No.: US 2007/0092831 A1
(43) Pub. Date: Apr. 26, 2007

(54) Radiation-absorbing polymeric materials and ophthalmic devices comprising same

(75) Inventors: Yu-Chin Lai, Pittsford, NY (US); Edmond T. Quinn, Rochester, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/257,217

(22) Filed: Oct. 24, 2005

(51) Int. Cl. G03C 1/00

(52) U.S. Cl. 430/270.1

(57) ABSTRACT

A radiation-absorbing polymeric material comprises units of a polymerizable UV-absorbing compound, a violet light-absorbing compound, and a monomer, and is capable of absorbing UV radiation, at least about 90 percent of light having wavelength of 425 nm, less than about 50 percent of light having wavelength of 450 nm, and less than about 30 percent of light having wavelength of 475 nm. Ophthalmic devices, such as contact lenses, corneal rings, corneal inlays, keratoprostheses, and intraocular lenses, are made from such polymeric material.

### BACKGROUND OF THE INVENTION

The present invention relates to radiation-absorbing polymeric materials and ophthalmic devices comprising the same. In particular, the present invention relates to organic polymeric materials capable of absorbing ultraviolet radiation and visible light in the violet region of the spectrum and ophthalmic devices comprising such polymeric materials.

Harmful effects to the eye from ultraviolet (“UV”) radiation (from about 100 nm to about 400 nm in wavelength) have long been known. UV radiation reaching the eye has wavelengths in the range of UV-B and UV-A (i.e., from about 280 nm to about 400 nm) and has been linked to cornea, lens, and retinal damage, including macular degeneration, and is believed to be a major cause of yellow-cataracts.

More recently, the undesirable effects of high transmittance levels of visible light having short wavelengths (from about 400 nm to about 500 nm) have received attention. This portion of the visible spectrum is commonly known as the violet-to-blue region. High levels of blue light have also been linked to retinal damage, macular degeneration, retinitis pigmentosa, and night blindness. On the other hand, violet light (light having wavelength in the range from about 400 nm to about 440 nm) is almost as photoactive as UV radiation and thus can be more harmful than blue light. UV radiation accounts for 67 percent of acute UV-blue phototoxicity between 350 nm and 700 nm. Violet light is responsible for 18 percent of acute UV-blue phototoxicity, but it contributes only 5 percent of scotopic vision. Conversely, blue light is responsible for 14 percent of UV-blue phototoxicity, but it provides more than 40 percent of scotopic vision due to the activity of rhodopsin at these wavelengths.

People with their natural lens (crystalline lens) of the eye opacified as a result of cataractogenesis require surgical removal of the diseased lens. This condition, known as aphakia, is incompatible with normal vision due to gross anomalies of the refraction and accommodation caused by the absence of the lens in the dioptric system of the eye, and must be corrected. One approach to restoration of normal vision is achieved by surgical insertion of an artificial plastic lens in the eye as a substitute for the removed crystalline lens. These artificial lenses are known as intraocular lenses (“IOLs”).

The natural lens is an essential component of the light filtering system. From age twenty on, the crystalline lens absorbs most of the UV-A radiation (between about 300 and about 400 nanometers), protecting the retina from the damaging effect of this radiation. Absorption is enhanced and shifted to longer wavelengths as the lens grows older and it expands eventually over the whole visible region. This phenomenon is correlated with the natural production of fluorescent chromophores in the lens and their age-dependent increasing concentration. Concomitantly, the lens turns yellower due to generation of certain pigments by the continuous photodegradation of the molecules which absorb in the UV-A region. This progressive pigmentation is responsible for the linear decrease in transmission of visible light, since the nearly complete absorption in the UV-A region remains constant after age twenty-five. When the natural lens is removed, the retina is no longer protected from the damaging effect of UV-A radiation. Therefore, any IOL intended to act as a substitute for the natural lens must provide protection to the retina against UV radiation. Some commercial IOLs also have been made to limit blue light with the goal to protect the eye from the now often-discussed damaging effect of this light. Such IOLs tend to give poor scotopic vision because blue light has been filtered out. However, as disclosed above, violet light is relative more phototoxic than blue light. Thus, it is more desirable to limit the transmission of violet light than blue light.

Therefore, there is a need to provide means for protecting the aphakic eye from harmful UV and violet radiation. In particular, it is very desirable to provide artificial lenses that absorb UV-A radiation and at least a portion of violet light. Furthermore, it is also very desirable to provide compositions for the manufacture of such lenses that are compatible with the internal environment of the eye. In addition, it is also desirable to provide other lenses, such as contact lenses, with the property of UV and violet light absorption.

### SUMMARY OF THE INVENTION

In general, the present invention provides radiation-absorbing polymeric materials. In one embodiment, the present invention provides polymeric materials capable of absorbing UV radiation and at least a portion of violet light incident thereon. In this disclosure, the term “violet light” means the portion of the electromagnetic radiation spectrum having wavelengths from about 400 nm to about 440 nm.

In one aspect, the present invention provides an organic copolymer comprising units of at least one polymerizable monomer, at least one polymerizable UV-radiation absorber, and at least one polymerizable electromagnetic-radiation absorber that is capable of absorbing at least a portion of violet light (hereinafter also referred to as a “violet-light absorber” or “violet light-absorbing compound”).

In another aspect, an organic polymer capable of absorbing UV-A radiation and at least a portion of violet light comprises units of at least one polymerizable monomer, at least one polymerizable UV-radiation absorber, at least one polymerizable violet-light absorber, and at least one polymerization crosslinking agent.

In still another aspect, an ophthalmic device comprises a polymeric material that comprises units of a UV-radiation absorber and a violet-light absorber.

In still another aspect, the UV-radiation absorber is a benzotriazole having a polymerizable functional group.

In a further embodiment, the violet-light absorber is an aromatic azo compound having at least a polymerizable functional group.

In yet another aspect, the present invention provides a method of making a polymeric material that is capable of absorbing UV radiation and at least a portion of violet light incident thereon. The method comprises reacting a UV radiation-absorbing compound having a first polymerizable functional group and a violet-light absorber having a second polymerizable functional group with a monomer having at least a third polymerizable functional group that is capable of forming a covalent bond with the first and second polymerizable functional groups.

Other features and advantages of the present invention will become apparent from the following detailed description and claims and the appended drawings.

### BRIEF DESCRIPTION OF THE DRAWINGS

FIG. 1 shows UV-VIS transmittance spectrum of a hydrogel film of the present invention comprising a benzotriazole and an azo dye.

### DETAILED DESCRIPTION OF THE INVENTION

In general, the present invention provides radiation-absorbing polymeric materials, which are capable of absorbing UV radiation and at least a portion of violet light incident thereon.

In the present disclosure, the terms “radiation” and “light,” as used herein, are interchangeable and mean electromagnetic radiation. The term “lower alkyl” means a straight alkyl radical having from 1 to, and including, 10 carbon atoms (such as, for example, from 1 to, and including, 5, or from 5 to, and including, 10 carbon atoms), or branched or cyclic alkyl radical having from 3 to, and including, 10 carbon atoms (such as, for example, from 3 to, and including, 5, or from 5 to, and including, 10 carbon atoms). The term “lower alkoxy” means a straight alkoxy radical having from 1 to, and including, 10 carbon atoms (such as, for example, from 1 to, and including, 5, or from 5 to, and including, 10 carbon atoms), or branched or cyclic alkoxy radical having from 3 to, and including, 10 carbon atoms (such as, for example, from 3 to, and including, 5, or from 5 to, and including, 10 carbon atoms). The term “lower alkenyl” means a straight alkenyl radical (i.e., having at least a carbon-carbon double bond) having 2 to, and including, 10 carbon atoms (such as, for example, from 2 to, and including, 5, or from 5 to, and including, 10 carbon atoms), or branched or cyclic alkenyl radical having 3 to, and including, 10 carbon atoms (such as, for example, from 3 to, and including, 5, or from 5 to, and including, 10 carbon atoms). In some embodiments, lower alkyl radicals comprise methyl, ethyl, propyl, isopropyl, butyl, or isobutyl group. In some other embodiments, lower alkenyl radicals comprise ethenyl, propenyl, isopropenyl, butenyl, or isobutenyl.

In one embodiment, the polymeric material is capable of absorbing UV-A radiation and at least about 80 percent of light having wavelengths from about 400 nm to about 425 nm incident on a piece of the polymeric material having a thickness of about 1 mm. In some other embodiments, the polymeric material is capable of absorbing UV-A radiation and at least 90 percent, or at least 95 percent, or at least 99 percent of light having wavelengths from about 400 nm to about 425 nm incident on a piece of the polymeric material having a thickness of about 1 mm.

In another embodiment, the polymeric material is capable of absorbing UV-A radiation (preferably, substantially all of UV-A radiation) and at least about 90 percent (preferably at least 95 percent, and more preferably at least 99 percent) of light having wavelength of 415 nm incident on a piece of the polymeric material having a thickness of about 1 mm.

A polymeric radiation-absorbing material of the present invention is a copolymer comprising units of at least one polymerizable monomer, at least one polymerizable UV-radiation absorber, and at least one polymerizable violet-light absorber.

In another embodiment, a polymeric radiation-absorbing material of the present invention is a copolymer comprising units of at least one polymerizable monomer, at least one polymerizable UV-radiation absorber, at least one polymerizable violet-light absorber, and at least one crosslinking agent.

In another aspect, a formulation for preparing a polymeric radiation-absorbing material also includes a material selected from the group consisting of polymerization initiators, chain transfer agents, plasticizers, light stabilizers, antioxidants, and combinations thereof.

In general, the polymerizable UV-radiation absorbers are selected from the group consisting of benzotriazoles and derivatives thereof, each of which also has at least a first polymerizable functional group that is capable of forming a covalent bond with the third polymerizable functional group on said at least one polymerizable monomer. The polymerizable violet-light absorbers suitable for the present invention are selected from the group consisting of azo dyes, such as aromatic azo dyes, each of which has at least a second polymerizable functional group that is capable of forming a covalent bond with a third polymerizable functional group on said at least one polymerizable monomer. Non-limiting examples of first, second, and third polymerizable functional groups are vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof. In one embodiment, the first, second, and third polymerizable functional groups are the same. In another embodiment, the first, second, and third polymerizable functional groups are different, but still are capable of reacting with each other. Several benzotriazoles and derivatives thereof are disclosed in U.S. Pat. No. 6,244,707 and published U.S. patent application Ser. No. 10/486,134, which are incorporated herein by reference in their entirety. Benzotriazoles and derivatives thereof that can be used in a composition of the present invention are represented generally by the following Formula (I): 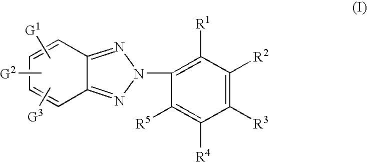
wherein each of G¹, G², and G³ is independently selected from the group consisting of hydrogen, halogen (e.g., fluorine, bromine, chlorine, and iodine), straight or branched chain thioether of 1 to 24 carbon atoms (the phrase “i to j carbon atoms,” as used herein, means that the chain can include any number of carbon atoms greater than or equal to i and smaller than or equal to j), straight or branched chain alkyl of 1 to 24 carbon atoms, straight or branched chain alkoxy of 1 to 24 carbon atoms, cycloalkoxy of 5 to 12 carbon atoms, phenoxy or phenoxy substituted by 1 to 4 alkyl of 1 to 4 carbon atoms, phenylalkoxy of 7 to 15 carbon atoms, perfluoroalkoxy of 1 to 24 carbon atoms, cyano, perfluoroalkyl of 1 to 12 carbon atoms, —CO-A, —COOA, —CONHA, —CON(A)₂, E³S—, E³SO—, E³SO₂—, nitro, —P(O)(C₈H₅)₂, —P(O)(OA)₂, 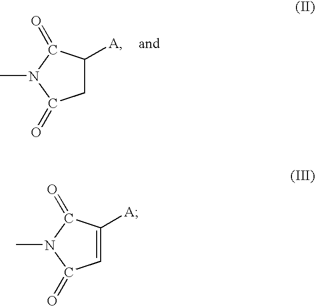
wherein A is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl and phenyl ring by 1 to 4 alkyl of 1 to 4 carbon atoms; and E³ is alkyl of 1 to 24 carbon atoms, hydroxyalkyl of 2 to 24 carbon atoms, alkenyl of 2 to 24 carbon atoms, cycloalkyl of 5 to 12 carbon atoms, phenylalkyl of 7 to 15 carbon atoms, aryl of 6 to 13 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms.

Each of R¹, R², R³, R⁴, and R⁵ is independently selected from the group consisting of hydrogen; hydroxyl; straight or branched chain alkyl of 1 to 24 carbon atoms; straight or branched chain alkoxy of 1 to 24 carbon atoms; cycloalkoxy of 5 to 12 carbon atoms; phenoxy or phenoxy substituted by 1 to 4 alkyl of 1 to 4 carbon atoms; phenylalkoxy of 7 to 15 carbon atoms; straight or branched chain alkenyl of 2 to 24 carbon atoms; cycloalkyl of 5 to 12 carbon atoms; phenylalkyl of 7 to 15 carbon atoms; aryl of 6 to 13 carbon atoms; said aryl or said phenylalkyl substituted on the aryl ring by 1 to 4 alkyl of 1 to 4 carbon atoms; and the group R⁶—R⁷—R⁸, where R⁶ is a direct bond or oxygen, R⁷ is direct bond or a linking group selected from the group consisting of divalent lower hydrocarbon groups (preferably C₁-C₆ hydrocarbon groups), —(O(CH₂)ₙ)ₘ—, —(OCH(CH₃)CH₂)ₘ—, (OCH₂CH(CH₃))ₘ—, ((CH₂)ₙOCH₂)ₘ—, (CH(CH₃)CH₂OCH₂)ₘ—, —(CH₂CH(CH₃)OCH₂)ₘ—, —(O(CH₂)ₙ)ₘ—(O(CH₂)—CHOH—CH₂))ₚ— group, and combinations thereof with a hetero atom selected from the group consisting of nitrogen, halogen, phosphorus, sulfur, and silicon; n is 2, 3, or 4; m and p are independently selected and are positive integers in the range from 1 to, and including, 10; and R⁸ is selected from the non-limiting polymerizable functional groups disclosed above; provided that at least one of R¹, R², R³, R⁴, and R⁵ is the group R⁶—R⁷—R⁸. In one embodiment, m and p are in the range from 1 to, and including, 5. In another embodiment, m and p are in the range from 1 to, and including, 3.

In one embodiment, suitable benzotriazole compounds are selected from the group of compounds having Formula (I); wherein each of G¹, G², and G³ is independently selected from the group consisting of hydrogen, halogen, hydroxyl, C₁-C₆ straight or branched chain alkyl, C₁-C₆ alkoxy groups, C₆-C₃₆ aryl, and substituted aryl groups; and wherein each of R¹, R², R³, R⁴, and R⁵ is independently selected from the group consisting of hydrogen, hydroxyl, lower alkyl, aryl, substituted aryl, and the group R⁶—R⁷—R⁸; provided that at least one of R¹, R², R³, R⁴, and R⁵ is the group R⁶—R⁷—R⁸; wherein R⁶, R⁷, and R⁸ are defined above.

In another embodiment, R⁷ includes one or more alkylsilyl groups, such as —Si(R¹¹)(R¹²)—, wherein R¹¹ and R¹² are independently chosen from the lower alkyl groups.

In one embodiment, m and p are in the range from 1 to, and including, 5. In another embodiment, m and p are in the range from 1 to, and including, 3.

In still another embodiment, R⁸ is selected from the group consisting of vinyl, acryloyloxy, and methacryloyloxy.

In still another embodiment, when R¹ is the hydroxyl group or R² is the t-butyl group, R⁸ is other than methacryloyloxy.

In still another embodiment, at least one of R³ and R⁵ is selected from the group consisting of hydrogen, hydroxyl, lower alkyl, aryl or substituted aryl, and the group R⁶—R⁷—R⁸, wherein R⁶, R⁷, and R⁸ are defined above.

In yet another embodiment, a benzotriazole-based UV radiation-absorbing compound is represented by Formula IV. 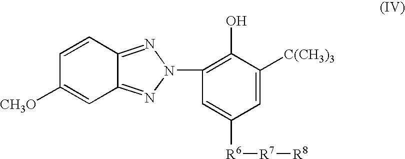
wherein R⁶, R⁷, and R⁸ are defined above.

In a further embodiment, a benzotriazole-based UV radiation-absorbing compound is represented by Formula V. 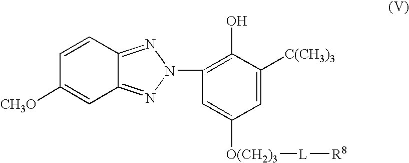
wherein L is a linking group comprising carbon, hydrogen, and oxygen having from 3 to 6 carbon atoms, and R⁸ the methacryloyloxy or acryloyloxy group. L can also include one or more heteroatoms, such as silicon or nitrogen, which can have substitutents, such as lower alkyls. The L group can also consist of carbon, hydrogen, and oxygen having from 3 to 6 carbon atoms. Although the applicants do not wish to be bound by any particular theory, it is believed that desirable radiation-absorbing properties of polymeric materials of the present invention are achievable with various linking L groups, as disclosed above.

In a further embodiment, a benzotriazole-based UV radiation-absorbing compound is represented by Formula VI. 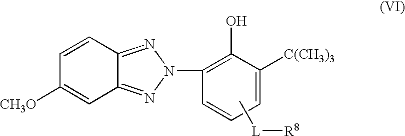
wherein L is a linking group comprising from 3 to 10 carbon atoms, and R⁸ is selected from the group consisting of the non-limiting polymerizable functional groups disclosed above. In one embodiment, the L group comprises carbon, hydrogen, and oxygen and has from 3 to 10 carbon atoms. In another embodiment, R⁸ is the methacryloyloxy or acryloyloxy group.

In a still further embodiment, a benzotriazole-based radiation-absorbing compound is represented by Formula VII. 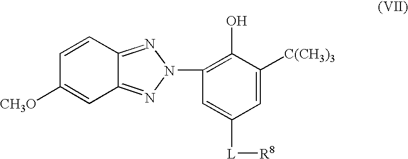
wherein L and R⁸ are as defined in Formula VI.

In a still further embodiment, a benzotriazole-based radiation-absorbing compound is represented by Formula VI or Formula VII, wherein L comprises the —Si(R¹¹)(R¹²)— group, R¹¹ and R¹² are defined above, and R⁸ is the methacryloyloxy or acryloyloxy group. In another embodiment, L is selected from the group consisting of divalent lower hydrocarbon groups (preferably C₁-C₆ hydrocarbon groups), —(O(CH₂)ₙ)ₘ—, —(OCH(CH₃)CH₂)ₘ—, —(OCH₂CH(CH₃))ₘ—, —((CH₂)ₙOCH₂)ₘ—, —(CH(CH₃)CH₂OCH₂)ₘ—, —(CH₂CH(CH₃)OCH₂)ₘ—, and —(O(CH₂)ₙ)ₘ—(O(CH₂)—CHOH—CH₂))ₚ— group, and combinations thereof; n is 2, 3, or 4; and m and p are independently selected and are positive integers in the range from 1 to, and including, 10. In another embodiment, L further comprises the —Si(R¹¹)(R¹²)— group, wherein R¹¹ and R¹² are as defined above.

Other benzotriazole-based UV radiation-absorbing compounds, which can be incorporated into a radiation-absorbing polymer, are 2-(5′-methacryloyloxymethyl-2′-hydroxyphenyl)-benzotriazole, 2-{3′-t-butyl-(5′-methacryloyloxy-t-butyl)-2′-hydroxyphenyl}-benzotriazole, 2-(5′-methacryloyloxy-t-butylphenyl)-benzotriazole, 2-(2′-hydroxy-5′-t-methacryloyloxyoctylphenyl)-benzotriazole, 5-chloro-2-(3′-t-butyl-5′-methacryloyloxy-t-butyl-2′-hydroxyphenyl)-benzotriazole, 5-chloro-2-(3′-t-butyl-2′-hydroxy-5′-methacryloyloxymethylphenyl)-benzotriazole, 2-(3′-sec-butyl-5′-methacryloyloxy-t-butyl-2′-hydroxyphenyl)-benzotriazole, 2-(2′-hydroxy-4′-methacryloyloxyoctyloxyphenyl)-benzotriazole, 2-(3′-t-amyl-5′-methacryloyloxy-t-amyl-2′-hydroxyphenyl)-benzotriazole, 2-(3′-α-cumyl-5′-methacryloyloxy-2′-hydroxyphenyl)-benzotriazole, 2-(3′-dodecyl-2′-hydroxy-5′-methacryloyloxymethylphenyl)-benzotriazole, 2-(3′-t-butyl-2′-hydroxy-5′-methacryloyloxy(2″-octyloxycarbonyl)ethylphenyl)-benzotriazole, 2-(3′-t-butyl-2′-hydroxy-5′-methacryloyloxy(2″-octyloxycarbonyl)ethylphenyl )-5-chloro-benzotriazole, 2-{3′-t-butyl-5′-methacryloyloxy-(2′-(2″-ethylhexyloxy)-carbonyl)ethyl-2′-hydroxyphenyl}-5-chloro-2H-benzotriazole, 2-(3′-t-butyl-2′-hydroxy-5′-methacryloyloxy-(2″-methoxycarbonyl)ethylphenyl )-5-chloro-benzotriazole, 2-{3′-t-butyl-2′-hydroxy-5′-(2″-methoxycarbonylethyl)phenyl}-benzotriazole, 2-{3′-t-butyl-2′-hydroxy-5′-methacryloyloxy-(2″-isooctyloxycarbonylethyl)phenyl}-benzotriazole, 2-{2′-hydroxy-3′-α-cumyl-5′-(methacryloyloxy-t-octyl)phenyl}-benzotriazole, 2-{2′-hydroxy-3′-t-octyl-5′-methacryloyloxy-α-cumyl)phenyl}-benzotriazole, 5-fluoro-2-{2′-hydroxy-3′-α-cumyl-5′-(methacryloyloxy-α-cumyl)phenyl}-benzotriazole, 5-chloro-2-{2′-hydroxy-3′-α-cumyl-5′-(methacryloyloxy-α-cumyl)phenyl}-benzotriazole, 5-chloro-2-{2′-hydroxy-3′-α-cumyl-5′-(methacryloyloxy-t-octyl)phenyl}-benzotriazole, 2-{3′-t-butyl-2′-hydroxy-5′-methacryloyloxy(2″-isooctyloxycarbonylethyl)phenyl}-5-chloro-benzotriazole, 5-trifluoromethyl-2-{2′-hydroxy-3′-α-cumyl-5′-(methacryloyloxy-t-octyl)phenyl}-benzotriazole, 5-trifluoromethyl-2-{2′-hydroxy-5′-(methacryloyloxy-t-octyl)phenyl}-benzotriazole, 5-trifluoromethyl-2-{2′-hydroxy-3′-t-octyl-5′-(methacryloyloxy-t-octyl)phenyl}-benzotriazole, 5-trifluoromethyl-2-{2′-hydroxy-3′-′-cumyl-5′-(methacryloyloxy-t-butyl)phenyl}-benzotriazole, 5-trifluoromethyl-2-{2′-hydroxy-3′-t-butyl-5′-(methacryloyloxy-t-butyl)phenyl}-benzotriazole, 5-trifluoromethyl-2-{2′-hydroxy-3′-α-cumyl-5′-(methacryloyloxy-α-cumyl)phenyl}-benzotriazole, 5-butylsulfonyl-2-{2′-hydroxy-3′-t-butyl-5′-(methacryloyloxy-t-butyl)phenyl}-benzotriazole, 5-phenylsulfonyl-2-{2′-hydroxy-3′-t-butyl-5′-(methacryloyloxy-t-butyl)phenyl}-benzotriazole, and the same benzotriazoles wherein the methacryloyloxy group is replaced by one of the first polymerizable functional groups disclosed above. In particular, the methacryloyloxy group is replaced by acryloyloxy, vinyl, or allyl group.

Benzotriazoles having a reactive vinyl group and a reactive methacryloyloxy group can be prepared by the method disclosed in U.S. Pat. Nos. 5,637,726 and 4,716,234, respectively. These patents are incorporated herein by reference in their entirety. Other reactive groups can replace the vinyl or methacryloyloxy groups in a similar synthesis.

Suitable violet-light absorbers for the present invention are the azo dyes, especially the aromatic azo dyes, represented below by Formula VIII. A composition of the present invention comprising an azo dye disclosed herein absorbs light predominantly in the wave length range from about 400 nm to about 440 nm. However, other compositions comprising an appropriate concentration (such as up to about 3-5 percent by weight) of an azo dye disclosed herein can absorb light at wavelengths longer than about 440 nm up to about 500 nm. 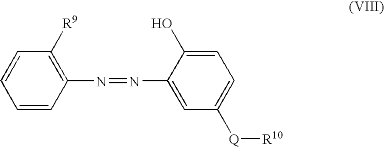
wherein Q is a linking group having from 1 to, and including, 20 carbon atoms and one or more atoms selected from the group consisting of hydrogen, oxygen, nitrogen, halogen, silicon, and combinations thereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

In one embodiment, R¹⁰ is selected from the group consisting of vinyl, allyl, acryloyl, acryloyloxy, methacryloyl, and methacryloyloxy. In another embodiment, R¹⁰ is selected from the group consisting of vinyl, acryloyloxy, and methacryloyloxy.

In a preferred embodiment, the azo dye is N-2{3′-(2″-methylphenylazo)-4′-hydroxyphenyl}ethyl vinylacetamide having Formula IX.

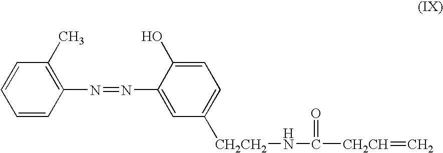

polymerizable monomers that are suitable for embodiments of the present invention include hydrophobic monomers, hydrophilic monomers, combinations thereof, and mixtures thereof. Non-limiting examples of such monomers are hydrophilic and hydrophobic vinylic monomers, such as lower alkyl acrylates and methacrylates, hydroxy-substituted lower alkyl acrylates and methacrylates, acrylamide, methacrylamide, lower alkyl acrylamides and methacrylamides, ethoxylated acrylates and methacrylates, hydroxy-substituted lower alkyl acrylamides and methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, amino—(the term “amino” also includes quaternary ammonium), mono-lower alkylamino- or di-lower alkylamino-lower alkyl acrylates and methacrylates, allyl alcohol, and the like. At least one polymerizable monomer is preferably selected from the group consisting of hydroxy-substituted C₂-C₄ alkyl(meth)acrylates, five- to seven-membered N-vinyl lactams, N,N-di-C₁-C₄ alkyl(meth)acrylamides and vinylically unsaturated carboxylic acids having a total of from 3 to 10 carbon atoms. Non-limiting examples of suitable vinylic monomers include 2-hydroxyethyl methacrylate (“HEMA”), 2-hydroxyethyl acrylate, acrylamide, methacrylamide, N,N-dimethylacrylamide, allyl alcohol, vinylpyrrolidone, glycerol methacrylate, N-(1,1-dimethyl-3-oxobutyl)acrylamide, and the like. Preferred vinylic comonomers are 2-hydroxyethyl methacrylate, 2-hydroxyethyl acrylate, N-vinylpyrrolidone, and dimethylacrylamide. The term “(meth)acrylate” means methacrylate or acrylate. Similarly, the term “(meth)acrylamide” means methacrylamide or acrylamide.

Other examples of polymerizable monomers are those that can be used to produce hydrogel polymeric materials. Hydrogel materials comprise hydrated, crosslinked polymeric systems containing water in an equilibrium state. Hydrogel materials contain about 5 weight percent water or more (up to, for example, about 80 weight percent). Non-limiting examples of materials suitable for the manufacture of medical devices, such as contact lenses, are herein disclosed.

Silicone hydrogels generally have a water content greater than about 5 weight percent and more commonly between about 10 to about 80 weight percent. Such materials are usually prepared by polymerizing a mixture containing at least one siloxane-containing monomer, a difunctional macromonomer, and at least one hydrophilic monomer. Typically, either the siloxane-containing macromonomer or a hydrophilic, difunctional monomer functions as a crosslinking agent (a crosslinking agent or crosslinker being defined as a monomer having multiple polymerizable functionalities) or a separate crosslinker may be employed. Applicable siloxane-containing monomeric units for use in the formation of silicone hydrogels are known in the art and numerous examples are provided, for example, in U.S. Pat. Nos. 4,136,250; 4,153,641; 4,740,533; 5,034,461; 5,070,215; 5,260,000; 5,310,779; and 5,358,995, which are incorporated herein by reference.

Exemplary siloxane-containing monomers include bulky polysiloxanylalkyl(meth)acrylic monomers, such as 3-methacryloxypropyltris(trimethyl-siloxy)silane or tris(trimethylsiloxy)silylpropyl methacrylate (“TRIS”).

Another class of representative silicon-containing monomers includes silicone-containing vinyl carbonate or vinyl carbamate monomers such as: 1,3-bis{(4-vinyloxycarbonyloxy)but-1-yl}tetramethyldisiloxane; 3-(trimethylsilyl)propyl vinyl carbonate; 3-(vinyloxycarbonylthio)propyl{tris(trimethylsiloxy)silane}; 3-{tris(trimethylsiloxy)silyl}propyl vinyl carbamate; 3-{tris(trimethylsiloxy)silyl}propyl allyl carbamate; 3-{tris(trimethylsiloxy)silyl}propyl vinyl carbonate; t-butyldimethylsiloxyethyl vinyl carbonate; trimethylsilylethyl vinyl carbonate; and trimethylsilylmethyl vinyl carbonate.

A formulation of the present invention desirably includes a suitable crosslinking monomer or agent. One class of such crosslinking monomers is the group of compounds having ethylenically unsaturated terminal groups having more than one unsaturated group. Suitable crosslinking agents include, for example, ethylene glycol dimethacrylate (“EGDMA”); diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate (“TMPTMA”), glycerol trimethacrylate, polyethyleneoxide mono- and diacrylates; and the like. The amount of crosslinking agent generally is less than about 10 percent (by weight). In some embodiments, the amount of crosslinking agent is less than about 5 percent (by weight).

A formulation for the preparation of a radiation-absorbing polymer of the present invention also preferably comprises a polymerization initiator. Several types of polymerization initiators are available, such as thermal initiators and photoinitiators. The latter type includes photoinitiators that are activated by high-energy radiation, such as UV or electron beam, and those that are activated by visible light. Preferred polymerization initiators are thermal initiators and visible-light photoinitiators (such as those that are activatable by light having wavelengths greater than about 450 nm; e.g., in the blue light wavelength range). Non-limiting examples of visible-light photoinitiators are fluorones disclosed in U.S. Pat. Nos. 5,451,343 and 5,395,862. More preferred polymerization initiators are thermal initiators. At a temperature in a range from about 80° C. to about 120° C., these initiators form radicals that start the crosslinking reaction. Non-limiting examples of suitable thermal initiators are organic peroxides, organic azo compounds, peroxycarboxylic acids, peroxydicarbonates, peroxide esters, hydroperoxides, ketone peroxides, azo dinitriles, and benzpinacol silyl ethers. Such thermal initiators can be present in the formulation in amounts from about 0.001 to about 10 percent by weight, preferably from about 0.05 to about 8 percent by weight, and more preferably from about 0.1 to about 5 percent by weight. Suitable thermal initiators are azobisisobutyronitrile (“AIBN”), benzoyl peroxide, hydrogen peroxide, t-butyl hydroperoxide, di-t-butyl peroxide, benzoyl hydroperoxide, 2,4-dichloro benzoyl peroxide, t-butyl peracetate, isopropyl peroxycarbonate, 2,2′-azobis{2-methyl-N-(2-hydroxyethyl)propionamide}, 2,2′-azobis(N-butyl-2-methylpropionamide), 2,2′-azobis(N-cyclohexyl-2-methyl propionamide), and combinations thereof.

Alternatively, a formulation for the preparation of a radiation-absorbing polymer of the present invention comprises a visible-light photoinitiator that is activated by light in the wavelength range from about 400 nm to about 700nm; in particular, from about 450 nm to about 500 nm. Non-limiting visible-light photoinitiators are camphorquinone; benzene and phenanthrenequinone; and mono- and bis-acylphosphine oxides, such as 2,4,6-trimethylbenzoyl-diphenylophosphine oxide, bis-(2,6-dichlorobenzoyl)-4-n-propylphenylphosphine oxide, and bis(2,6-dichlorobenzoyl)-4-n-butylphenylphosphine oxide. Other visible-light photoinitiators are substituted fluorone compounds, such as those disclosed in U.S. Pat. Nos. 5,451,343 and 5,395,862, which are incorporated herein by reference in their entirety. Such a visible-light photoinitiator is more advantageously used in a formulation of the present invention than a conventional UV photoinitiator in the polymerization art.

A radiation-absorbing polymer of the present invention comprises an effective proportion of the units of the polymerizable radiation-absorbing compounds for absorbing substantially all of the UV radiation and at least a portion of the violet light incident thereon (e.g., at least 80 percent, or at least 90 percent, or at least 95 percent, or at least 99 percent, at wavelength of 425 nm).

Typically, a radiation-absorbing polymer of the present invention comprises the UV radiation-absorbing component in an amount from about 0.001 to about 3 percent by weight of the polymer, preferably from about 0.01 to about 2 percent by weight, and more preferably from about 0.01 to about 1 percent by weight; and the violet-light absorber in an amount from about 0.001 to about 1 percent by weight of the polymer, preferably from about 0.01 to about 0.5 percent by weight, and more preferably from about 0.01 to about 0.2 percent by weight.

In one embodiment, a radiation-absorbing polymer of the present invention is capable of absorbing substantially all of the UV-A radiation and at least 80 percent of light in the wavelength range from about 400 nm to about 425 nm incident on a piece of the polymer having a thickness of about 1 mm. In some other embodiments, the polymeric material is capable of absorbing UV-A radiation and at least 90 percent, or at least 95 percent, or at least 99 percent of light having wavelengths from about 400 nm to about 425 nm incident on a piece of the polymeric material having a thickness of about 1 mm.

In another embodiment, the polymeric material is capable of absorbing UV-A radiation (preferably, substantially all of UV-A radiation) and at least about 90 percent (or at least about 95 percent, or at least about 99 percent) of light having wavelength of 415 nm incident on a piece of the polymeric material having a thickness of about 1 mm.

In still another embodiment, a radiation-absorbing polymer of the present invention is capable of absorbing substantially all of the UV-A radiation, at least about 90 percent (or at least about 95 percent, or at least about 99 percent) of light at wavelength of 425 nm, and less than about 30 percent (or, alternatively, less than about 20 percent, or less than about 15 percent) of light at wavelength of 475 nm incident on a piece of the polymer having a thickness of about 1 mm. Such a radiation-absorbing polymer has advantage over prior-art polymers in the art of manufacture of ophthalmic devices because it at least does not present a risk of impairment of the scotopic vision in the blue light region.

In a further embodiment, a radiation-absorbing polymer of the present invention is also capable of absorbing at least about 90 percent (or at least about 95 percent, or at least about 99 percent) of light at wavelength of 425 nm, less than about 50 percent (or, alternatively, less than about 40 percent) of light having wavelength of 450 nm, and less than about 30 percent (or, alternatively, less than about 20 percent, or less than about 15 percent) of light at wavelength of 475 nm.

Test 1: Establishing Equivalence of Transmittance Data of an Azo Dye in Solution and in a Polymeric Material

A solution of 140 ppm (parts per million) (by weight) of the azo dye having Formula IX in isopropanol (IPA) was prepared. UV-VIS absorbance/transmittance spectrum was obtained for this solution with a path length of about 1 cm. The transmittance data at wavelengths of 425 nm and 450 nm are shown in Table 1, along with transmittance data at the same wavelengths for solutions having other concentrations of the same dye calculated using Beer's Law.

TABLE 1

| Concentration of | Transmittance at | Transmittance at |
|---|---|---|
| Azo Dye | 425 nm | 450 nm |
| (ppm) | (%) | (%) |
| 140 | 63 | 77 |
| 200 | 53⁽¹⁾ | 70⁽¹⁾ |
| 500 | 19⁽¹⁾ | 39⁽¹⁾ |
| 700 | 10⁽¹⁾ | 27⁽¹⁾ |

Note:
⁽¹⁾calculated from data obtained at 140 ppm, using Beer's Law

Plastic buttons were then made with polymerizable compositions consisting of 80 parts (by weight) of 2-hydroxyethyl methacrylate, 20 parts (by weight) of methyl methacrylate, 0.5 part (by weight) of EGDMA, 0.5 part (by weight) of 2,2′-azobis(2,4-dimethylvaleronitrile) (available from Monomer-Polymer & Dajac Labs, Feasterville, Pa.) thermal polymerization initiator, and 250, 500, or 750 ppm (by weight) of azo dye having Formula IX. The polymerizable compositions were cured under heat at 50° C. for about 2 hours. The buttons were cut into pieces having thickness of about 1 mm, and UV-VIS spectra were obtained. Results of the transmittance data at wavelengths of 425 nm and 450 nm are shown in Table 2.

TABLE 2

| Concentration | Transmittance | Transmittance |
|---|---|---|
| of Azo Dye | at 425 nm | at 450 nm |
| (ppm) | (%) | (%) |
| 250 | 40 | 61 |
| 500 | 20 | 40 |
| 750 | 10 | 26 |

A comparison of the data in Tables 1 and 2 reveals that the transmittance data of the 1-mm thick plastic pieces are very well predicted by the transmittance data obtained from a solution with a path length of 1 cm.

Test 2: Hydrogel Film Comprising a UV-Radiation Absorber and a Violet-Light Absorber

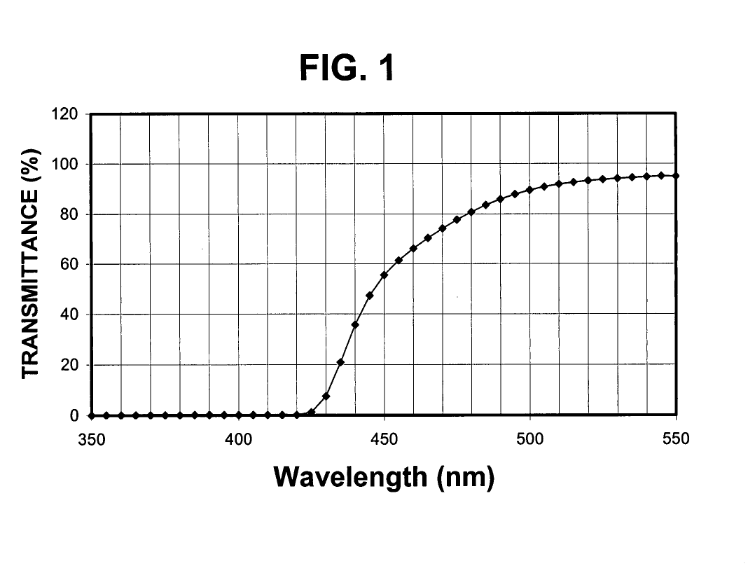

A polymerizable mixed composition was made, consisting of 84.5 parts (by weight) of HEMA, 14 parts (by weight) of methyl methacrylate, 0.566 part (by weight) of EGDMA, 0.018 part (by weight) of the azo dye having Formula IX, 2.26 parts (by weight) of a UV-radiation absorber having Formula V (wherein L is the —Si(CH₃)₂— group and R₈ is the vinyl group), and 0.5 part (by weight) of 2,2′-azobis(2,4-dimethylvaleronitrile) (available from Monomer-Polymer & Dajac Labs, Feasterville, Pa.) thermal polymerization initiator. The mixed composition was cast between two silane-treated glass plates, separated with a Teflon™ gasket. After curing under heat at 80° C. for about 2 hours, the cured film was released and extracted with isopropanol overnight. The extracted film was then hydrated in water to give a hydrogel having 29% water. The thickness of the film was 0.86-0.88 mm, which is typical of the thickness of IOLs. The film was yellow in color, but optically clear, without any sign of haziness. The UV-VIS transmittance data of the hydrogel film is shown in FIG. 1. The film has desirable absorption characteristic for IOLs. The data shows that the film absorbed all of light having wavelengths of 425 nm or shorter and about 20 percent at wavelength of 475 nm. From this data, it is possible to achieve transmittance of about 8 percent at wavelength of 425 nm, about 70 percent at 450nm, and about 86 percent at 475 nm by reducing the concentrations of both radiation absorbers by 40 percent.

Test 3—Hydrogel Film Properties

A monomer mix consisted of HEMA (17.035 g), MMA (2.8116 g), and EGDMA (0.1616 g) was prepared (weight ratio was 85.42:14.06:0.81). Then 7.9973 g of this monomer mix was added with 0.0021 g of azo dye having Formula IX, 0.1963 g of UV-radiation absorber having Formula V (wherein L is the —Si(CH₃)₂— group and R₈ is the vinyl group), and 0.0422 g of 2,2′-azobis(2,4-dimethylvaleronitrile)thermal polymerization initiator. The mix composition was cast between two silane-treated glass plates, separated with a Teflon™ gasket. After curing under heat at 85° C. for about 2 hours, the cured film was released and extracted with isopropanol overnight. The film was then hydrated to produce hydrogel film, which had a water content of 25.2%, tensile modulus of 162 g/mm², an elongation of 227%, and a tear strength of 41 g/mm.

The mechanical properties and water content were comparable to that of an existing commercial product based on HEMA/MMA/EGDMA (composition of 85.5/14/0.52), which has a water content of 26%, a tensile modulus of 134 g/mm², an elongation of 179%, and a tear strength of 29 g/mm).

The present invention also provides a method for producing a radiation-absorbing polymeric material. The method comprises reacting a UV radiation-absorbing compound having a first polymerizable functional group and a violet-light absorber having a second polymerizable functional group with a monomer having a third polymerizable functional group that is capable of forming a covalent bond with the first and second polymerizable functional groups. Non-limiting examples of the UV radiation-absorbing compounds, the violet-light absorbers, the monomers, and the polymerizable functional groups are disclosed above. A UV radiation-absorbing compound and a violet-light absorber are present in effective amounts such that the cured polymeric material absorbs UV radiation (in particular, UV-A radiation) and at least a portion of violet light. Exemplary ranges for such amounts are disclosed above.

In one aspect, the method comprises reacting the UV radiation-absorbing compound, the violet-light absorber, and the monomer in the presence of a crosslinking agent selected from the group of crosslinking agents disclosed above. An additional material selected from the group consisting of polymerization initiators, chain transfer agents, plasticizers, light stabilizers, antioxidants, and combinations thereof can be included in the reaction formulation, if desired. These materials can be used in amounts from about 0.01 to about 2 percent by weight of the formulation mixture. Non-limiting chain transfer agents are mercapto compounds, such as octyl mercaptan, dodecyl mercaptan, mercaptoacetic acid, mercaptopropionic acid, mercaptosuccinic acid, and 2-mercaptoethanol. Non-limiting examples of antioxidants are phenol, quinones, benzyl compounds, ascorbic acid, and their derivatives, such as alkylated monophenols, alkylthiomethylphenols, alkylidenebisphenols, acylaminophenols, hydroquinones and alkylated hydroquinones, aromatic hydroxybenzyl compounds, and benzylphosphonates. Non-limiting examples of light stabilizers are steric hindered amines, such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, 1-(2-hydroxy-2-methylpropoxy)-4-hydroxy-2,2,6,6-tetramethylpiperidine, 1-(2-hydroxy-2-methylpropoxy)oxo-2,2,6,6-tetramethylpiperidine, bis(1-(2-hydroxy-2-methylpropoxy)-2,2,6,6-tetramethyl-piperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, and bis(1-(2-hydroxy-2-methylpropoxy)-2,2,6,6-tetramethylpiperidin-4-yl)glutarate. It is further desirable to use such plasticizers, light stabilizers, and antioxidants that include polymerizable functional groups capable of forming bonds with the first, second, or third polymerizable functional groups.

A formulation comprising a polymerizable UV radiation-absorbing compound, a violet-light absorber, a monomer, and a crosslinking agent, as disclosed above, can be used to make almost any type of ophthalmic devices, such as contact lenses, corneal rings, corneal inlays, keratoprostheses, and IOLs. In one aspect, the formulation is used to make IOLs that are soft, elongable, and capable of being rolled or folded and inserted through a relative small incision in the eye, such as an incision of less than about 3.5 mm.

A method of making an ophthalmic device that is capable of absorbing UV radiation (in particular, UV-A radiation) and at least a portion of violet light comprises: (a) providing a mixture comprising a polymerizable UV-radiation absorber, a polymerizable violet-light absorber, and a polymerizable monomer, which can be selected from the polymerizable UV absorbers, polymerizable violet-light absorbers, and polymerizable monomers disclosed above; (b) disposing the mixture in a mold cavity, which forms a shape of the ophthalmic device; and (c) curing the mixture under a condition and for a time sufficient to form the ophthalmic device. In one aspect, the mixture also comprises a crosslinking agent, or a polymerization initiator, or both. The polymerization initiator is preferably a thermal polymerization initiator. Radiation-activated polymerization initiators, which are activatable by visible light (e.g., blue light), also can be used. The crosslinking agents and the polymerization initiators can be selected from those disclosed above. The curing can be carried out at an elevated temperature such as in the range from greater than ambient temperature to about 120° C. In some embodiments, the curing is carried out at a temperature from slightly higher than ambient temperature to about 100° C. A time from about 1 minute to about 48 hours is typically adequate for the curing.

Another method of making an ophthalmic device that is capable of absorbing UV radiation (in particular, UV-A radiation) and at least a portion of violet light comprises: (a) providing a mixture comprising a polymerizable UV radiation absorber, a polymerizable violet-light absorber, and a polymerizable monomer which can be selected from the polymerizable UV absorbers and polymerizable monomers disclosed above; (b) casting the mixture under a condition and for a time sufficient to form a solid block; and (c) shaping the block into the ophthalmic device. In one aspect, the mixture also comprises a crosslinking agent, or a polymerization initiator, or both. The polymerization initiator is preferably a thermal polymerization initiator. Radiation-activated polymerization initiators, which are activatable by visible light (e.g., blue light), also can be used. The crosslinking agents and the polymerization initiators can be selected from those disclosed above. The casting can be carried out at an elevated temperature such as in the range from greater than ambient temperature to about 120° C. In some embodiments, the casting is carried out at a temperature higher than ambient temperature but lower than about 100° C. A time from about 1 minute to about 48 hours is typically adequate for the polymerization of mixtures of the present invention. The shaping can comprise cutting the solid block into wafers, and lathing or machining the wafers into the shape of the final ophthalmic device.

Ophthalmic medical devices manufactured using radiation-absorbing polymeric materials of the present invention are used as customary in the field of ophthalmology. For example, in a surgical cataract procedure, an incision is placed in the cornea of an eye. Through the corneal incision the cataractous natural lens of the eye is removed (aphakic application) and an IOL is inserted into the anterior chamber, posterior chamber or lens capsule of the eye prior to closing the incision. However, the subject ophthalmic devices may likewise be used in accordance with other surgical procedures known to those skilled in the field of ophthalmology.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

1. A radiation-absorbing polymeric material comprising 1 wt % to 3 wt % of a polymerizable UV radiation-absorbing benzotriazole or derivative thereof, 0.001 wt % to 0.2 wt % of a polymerizable violet light-absorbing compound, and a polymerizable monomer, wherein the radiation-absorbing polymeric material absorbs substantially all UV-A radiation, at least about 80 percent of light having wavelengths from about 400 nm to about 425 nm and absorbs less than about 30 percent of light having wavelength of 475 nm incident on a piece of the polymeric material having a thickness of about 1 mm.

2. The radiation-absorbing material of claim 1, wherein the radiation-absorbing polymeric material absorbs at least about 90 percent of light having wavelength of 415 nm.

3. (canceled)

4. The radiation-absorbing material of claim 2, wherein the radiation-absorbing polymeric material absorbs less than about 20 percent of light having wavelength of 475 nm.

5. The radiation-absorbing material of claim 1, wherein the violet light-absorbing compound is an azo dye.

6. The radiation-absorbing polymeric material of claim 5, wherein the radiation-absorbing polymeric material absorbs at least about 90 percent of light having wavelength of 425 nm, and less than about 50 percent of light having wavelength of 450 nm.

7. (canceled)

8. The radiation-absorbing material of claim 5, wherein the benzotriazole has a formula of 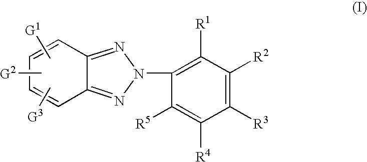
wherein each of G¹, G², and G³ is independently selected from the group consisting of hydrogen, halogen, straight and branched chain thioether of 1 to 24 carbon atoms, straight and branched chain alkyl of 1 to 24 carbon atoms, straight and branched chain alkoxy of 1 to 24 carbon atoms, cycloalkoxy of 5 to 12 carbon atoms, phenoxy or phenoxy substituted by 1 to 4 alkyl groups of 1 to 4 carbon atoms, phenylalkoxy of 7 to 15 carbon atoms, perfluoroalkoxy of 1 to 24 carbon atoms, cyano, perfluoroalkyl of 1 to 12 carbon atoms, —CO-A, COOA, —CONHA, —CON(A)₂, E³S—, E³SO—, E³SO₂—, nitro, —P(O)(C₈H₅)₂, —P(O)(OA)₂, 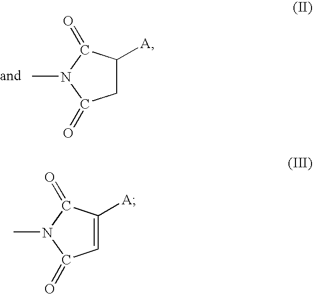
wherein A is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl and phenyl ring by 1 to 4 alkyl of 1 to 4 carbon atoms; and E³ is alkyl of 1 to 24 carbon atoms, hydroxyalkyl of 2 to 24 carbon atoms, alkenyl of 2 to 24 carbon atoms, cycloalkyl of S to 12 carbon atoms, phenylalkyl of 7 to 15 carbon atoms, aryl of 6 to 13 carbon atoms and said aryl substituted by one or two alkyl groups of 1 to 4 carbon atoms or 1,1,2,2-tetrahydroperfluoroalkyl where the perfluoroalkyl moiety is of 6 to 16 carbon atoms; each of R¹, R², R³, R⁴, and R⁵ is independently selected from the group consisting of hydrogen, hydroxyl, straight and branched chain alkyl of 1 to 24 carbon atoms, straight and branched chain alkoxy of 1 to 24 carbon atoms, cycloalkoxy of 5 to 12 carbon atoms, phenoxy and phenoxy substituted by 1 to 4 alkyl groups of 1 to 4 carbon atoms, phenylalkoxy of 7 to 15 carbon atoms, straight and branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl or phenyl ring by 1 to 4 alkyl groups of 1 to 4 carbon atoms, provided that at least one of R¹, R², R³, R⁴, and R⁵ is the group R⁶—R⁷—R⁸, wherein R⁶ is a direct bond or oxygen, R⁷ is direct bond or a linking group selected from the group consisting of divalent hydrocarbon groups having 1 to 6 carbon atoms, —(O(CH₂)ₙ)ₘ—, —(OCH(CH₃)CH₂)ₘ—, —(OCH₂CH(CH₃))ₘ—, —((CH₂)ₙOCH₂)ₙ—, —(CH(CH₃)CH₂OCH₂)ₘ—, —(CH₂CH(CH₃)OCH₂)ₘ—, —(O(CH₂)ₙ)ₘ—(O(CH₂)—CHOH—CH₂))ₚ— groups, and combinations thereof with one or more hetero atoms selected from the group consisting of nitrogen, halogen, phosphorus, sulfur, and silicon; n is 2, 3, or 4; m and p are independently selected and are positive integers in the range from 1 to, and including, 10; and R⁸ is a polymerizable functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, and styryl.

9. The radiation-absorbing material of claim 5, wherein the benzotriazole is selected from the group consisting of 2-(5′-methacryloyloxymethyl-2′-hydroxyphenyl)-benzotriazole, 2-{3′-t-butyl-(5′-methacryloyloxy-t-butyl)-2′-hydroxyphenyl}-benzotriazole, 2-(5′-methacryloyloxy-t-butylphenyl)-benzotriazole, 2-(2′-hydroxy-5′-t-methacryloyloxyoctylphenyl)-benzotriazole, 5-chloro-2-(3′-t-butyl-5′-methacryloyloxy-t-butyl-2′-hydroxyphenyl)-benzotriazole, 5-chloro-2-(3′-t-butyl-2′-hydroxy-5′-methacryloyloxymethylphenyl)-benzotriazole, 2-(3′-sec-butyl-5′-methacryloyloxy-t-butyl-2′-hydroxyphenyl)-benzotriazole, 2-(2′-hydroxy-4′-methacryloyloxyoctyloxyphenyl)-benzotriazole, 2-(3′-t-amyl-5′-methacryloyloxy-t-amyl-2′-hydroxyphenyl)-benzotriazole, 2-(3′-α-cumyl-5′-methacryloyloxy-2′-hydroxyphenyl)-benzotriazole, 2-(3′-dodecyl-2′-hydroxy-5′-methacryloyloxymethylphenyl)-benzotriazole, 2-(3′-t-butyl-2′-hydroxy-5′-methacryloyloxy(2″-octyloxycarbonyl)ethylphenyl)-benzotriazole, 2-(3′-t-butyl-2′-hydroxy-5′-methacryloyloxy(2″-octyloxycarbonyl)ethylphenyl)-5-chloro-benzotriazole, 2-{3′-t-butyl-5′-methacryloyloxy-(2′-(2″-ethylhexyloxy)-carbonyl)ethyl-2′-hydroxyphenyl}-5-chloro-2H-benzotriazole, 2-(3′-t-butyl-2′-hydroxy-5′-methacryloyloxy-(2″-methoxycarbonyl)ethylphenyl)-5-chloro-benzotriazole, 2-{3′-t-butyl-2′-hydroxy-5′-(2″-methoxycarbonylethyl)phenyl}-benzotriazole, 2-{3′-t-butyl-2′-hydroxy-5′-methacryloyloxy-(2″-isooctyloxycarbonylethyl)phenyl}-benzotriazole, 2-{2′-hydroxy-3′-α-cumyl-5′-(methacryloyloxy-t-octyl)phenyl}-benzotriazole, 2-{2′-hydroxy-3′-t-octyl-5′-methacryloyloxy-α-cumyl)phenyl}-benzotriazole, 5-fluoro-2-{2′-hydroxy-3′-α-cumyl-5′-methacryloyloxy-α-cumyl)phenyl}-benzotriazole, 5-chloro-2-{2′-hydroxy-3′-α-cumyl-5′-(methacryloyloxy-α-cumyl)phenyl}-benzotriazole, 5-chloro-2-{2′-hydroxy-3′-α-cumyl-5′-(methacryloyloxy-t-octyl)phenyl}-benzotriazole, 2-{3′-t-butyl-2′-hydroxy-5′-methacryloyloxy(2″-isooctyloxycarbonylethyl)phenyl}-5-chloro-benzotriazole, 5-trifluoromethyl-2-{2′-hydroxy-3′-α-cumyl-5′-(methacryloyloxy-t-octyl)phenyl}-benzotriazole, 5-trifluoromethyl-2-{2′-hydroxy-5′-(methacryloyloxy-t-octyl)phenyl}-benzotriazole, 5-trifluoromethyl-2-{2′-hydroxy-3′-t-octyl-5′-(methacryloyloxy-t-octyl)phenyl}-benzotriazole, 5-trifluoromethyl-2-{2′-hydroxy-3′-α-cumyl-5′-(methacryloyloxy-t-butyl)phenyl}-benzotriazole, 5-trifluoromethyl-2-{2′-hydroxy-3′-t-butyl-5′-(methacryloyloxy-t-butyl)phenyl}-benzotriazole, 5-trifluoromethyl-2-{2′-hydroxy-3′-α-cumyl-5′-(methacryloyloxy-α-cumyl)phenyl}-benzotriazole, 5-butylsulfonyl-2-{2′-hydroxy-3′-t-butyl-5′-(methacryloyloxy-t-butyl)phenyl}-benzotriazole, and 5-phenylsulfonyl-2-{2′-hydroxy-3′-t-butyl-5′-(methacryloyloxy-t-butyl)phenyl}-benzotriazole.

10. The radiation-absorbing material of claim 5, wherein the benzotriazole has a formula of 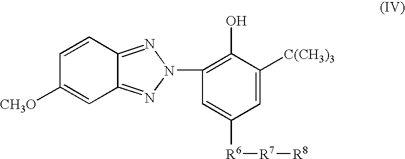
wherein R⁶ is a direct bond or oxygen, R⁷ is direct bond or a linking group selected from the group consisting of divalent hydrocarbon groups having 1 to 6 carbon atoms, —O(CH₂)ₙ)ₘ—, —(OCH(CH₃)CH₂)ₘ—, —(OCH₂CH(CH₃))ₘ—, —((CH₂)ₙOCH₂)ₘ—, —(CH(CH₃)CH₂OCH₂)ₘ—, —(CH₂CH(CH₃)OCH₂)ₘ—, —(O(CH₂)ₙ)ₘ—(O(CH₂)—CHOH—CH₂))ₚ— groups, and combinations thereof with one or more hetero atoms selected from the group consisting of nitrogen, halogen, phosphorus, sulfur, and silicon; n is 2, 3, or 4; m and p are independently selected and are positive integers in the range from 1 to, and including, 10; and R⁸ is a polymerizable functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, and styryl; provided that at least one of R¹, R², R³, R⁴, and R⁵ is the group R⁶—R⁷—R⁸.

11. The radiation-absorbing material of claim 5, wherein the benzotriazole has a formula of 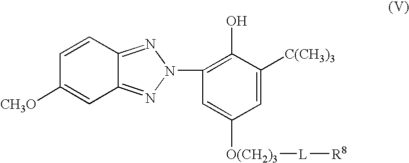
wherein L is a linking group comprising carbon, hydrogen, and oxygen having from 3 to 6 carbon atoms; and R⁸ the methacryloyloxy or acryloyloxy group.

12. The radiation-absorbing material of claim 5, wherein the azo dye has a formula of 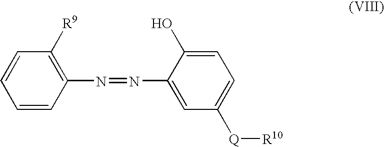
wherein Q is a linking group having from 1 to, and including, 20 carbon atoms and one or more atoms selected from the group consisting of hydrogen, oxygen, nitrogen, halogen, silicon, and combinations thereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

13. The radiation-absorbing material of claim 5, wherein the azo dye has a formula of

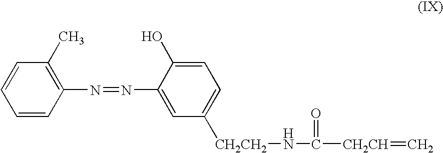

14. The radiation-absorbing material of claim 5, wherein the benzotriazole has a formula of 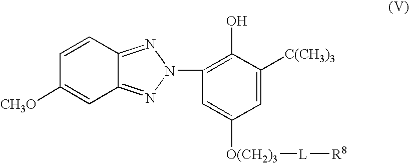
wherein L is a linking group consisting of carbon, hydrogen, and oxygen having from 3 to 6 carbon atoms; and R⁸ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof;
and the azo dye has a formula of 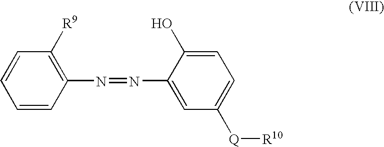
wherein Q is a linking group having from 1 to, and including, 20 carbon atoms and one or more atoms selected from the group consisting of hydrogen, oxygen, nitrogen, halogen, silicon, and combinations thereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

15. The radiation-absorbing material of claim 14, wherein the polymerizable monomer is selected from the group consisting of siloxane-containing monomers and macromonomers, lower alkyl acrylates, and lower alkyl methacrylates, and combinations thereof.

16. (canceled)

17. The radiation-absorbing material of claim 16, further comprising units of crosslinking monomer is selected from the group consisting of ethylene glycol dimethacrylate (“EGDMA”); diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate (“TMPTMA”), glycerol trimethacrylate, polyethyleneoxide acrylates, polyethyleneoxide diacrylates; and combinations thereof.

18. (canceled)

19. A method of producing a radiation-absorbing polymeric material, the method comprising reacting 1 wt % to 3 wt % of a UV radiation-absorbing benzotriazole or derivative thereof having a first polymerizable functional group and 0.001 wt % to 0.2 wto/a of a polzale violet light-absorbing compound having a second polymerizable functional group with a monomer having a third polymerizable functional group that can form a covalent bond with the first and second polymerizable functional groups, and a crosslinking agent; wherein the polymeric material absorbs substantially all UV-A radiation, at least about 90 percent of light having wavelength of 425 nm, less than about 50 percent of light having wavelength of 450 nm, and less than about 30 percent of light having wavelength of 475 nm; said light being incident on the polymeric material having a thickness of about 1 mm.

20. The method of claim 19, wherein said reacting is carried out in a presence of a thermal polymerization initiator and at a temperature higher than ambient temperature but lower than about 120° C. for a time sufficient to produce said polymeric material.

21. (canceled)

22. The method of claim 19, wherein the benzotriazole has a formula of 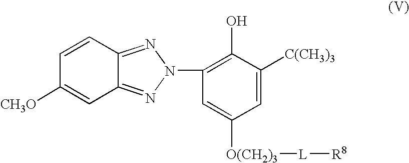
wherein L is a linking group consisting of carbon, hydrogen, and oxygen having from 3 to 6 carbon atoms; and R⁸ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof;
and the violet-light absorber has a formula of 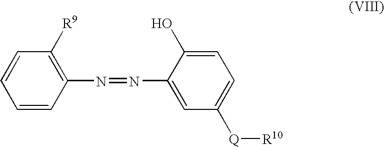
wherein Q is a linking group having from 1 to, and including, 20 carbon atoms and one or more atoms selected from the group consisting of hydrogen, oxygen, nitrogen, halogen, silicon, end combinations hereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

23. An ophthalmic device comprising a radiation-absorbing polymeric material that comprises 1 wt % to 3 wt % of a polymerizabie UV radiation-absorbing benzotriazole or a derivative thereof, 0.001 wt % to 0.2 wt % of a polymerizable violet light-absorbing compound, and a polymerizable monomer; wherein the radiation-absorbing polymeric material absorbs substantially all UV-A radiation, at least about 90 percent of light having wavelength of 425 nm, less than about 50 percent of light having wavelength of 450 nm, and less than about 30 percent of light having wavelength of 475 nm.

24. (canceled)

25. The ophthalmic device of claim 23, wherein the the violet light-absorbing compound is an azo dye.

26. (canceled)

27. The ophthalmic device of claim 23, wherein the ophthalmic device is selected from the group consisting of contact lenses, corneal rings, corneal inlays, keratoprostheses, and intraocular lenses.

28. The ophthalmic device of claim 25, wherein the ophthalmic device is selected from the group consisting of contact lenses, corneal rings, corneal inlays, keratoprostheses, and intraocular lenses.

29. The ophthalmic device of claim 23, wherein the benzotriazole has a formula of 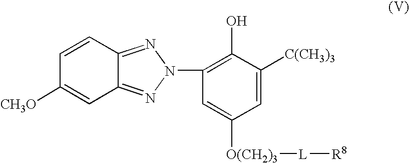
wherein L is a linking group consisting of carbon, hydrogen, and oxygen having from 3 to 6 carbon atoms; and R⁸ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof;
and the violet-light absorber has a formula of 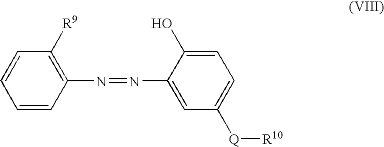
wherein Q is a linking group having from 1 to, and including, 20 carbon atoms and one or more atoms selected from the group consisting of hydrogen, oxygen, nitrogen, halogen, silicon, and combinations thereof: R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

30. A method of making an ophthalmic device, the method comprising:
(a) providing a mixture comprising 1 wt % to 3 wt % of a polymerizable UV radiation-absorbing benzotriazole or derivative thereof, 0.001 wt % to 0.2 wt % of a violet light-absorbing compound, and a polymerizable monomer;
(b) disposing the mixture in a mold cavity, which forms a shape of the ophthalmic device; and
(c) curing the mixture under a condition and for a time sufficient to form the ophthalmic device;
wherein the ophthalmic device is capable of absorbing absorbs substantially all UV-A radiation, at least about 90 percent of light having wavelength of 425 nm, less than about 50 percent of light having wavelength of 450 nm, and less than about 30 percent of light having wavelength of 475 nm, said light incident on the ophthalmic device.

31. A method of making an ophthalmic device, the method comprising:
(a) providing a mixture comprising 1 wt % to 3 wt % of a polymerizable UV radiation-absorbing benzotriazole or derivative thereof, 0.001 wt % to 0.2 wt % of a violet light-absorbing compound, and a polymerizable monomer;
(b) casting the mixture under a condition and for a rime sufficient to form a solid block; and
(c) shaping the block into the ophthalmic device;
wherein the ophthalmic device absorbs substantially all UV-A radiation, at least about 90 percent of light having wavelength of 425 nm, less than about 50 percent of light having wavelength of 450 nm, and less than about 30 percent of light having wavelength of 475 nm, said light incident on the ophthalmic device.

32. The method of claim 31, wherein the shaping comprises cutting the solid block into wafers, and machining the wafers into a shape of the final ophthalmic device.

33. The radiation-absorbing material of claim 5, wherein the benzotriazole has a formula of 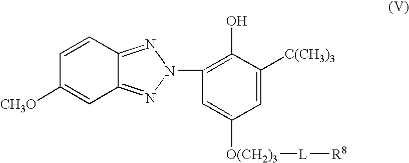
wherein L is —Si(CH₃)₂—.

34. The method of claim 19, wherein the benzotriazole has a formula of 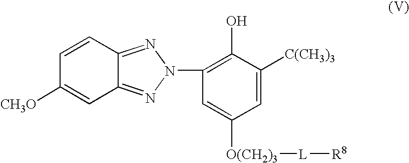
wherein L is —Si(CH₃)₂—.

35. The ophthalmic device of claim 23, wherein the benzotriazole has a formula of 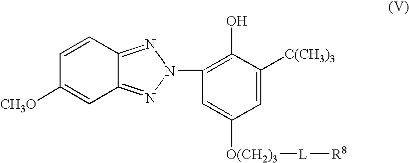
wherein L is —Si(CH₃)₂—.

36. The method of claim 30, wherein the benzotriazole has a formula of 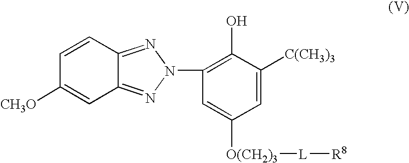
wherein L is —Si(CH₃)₂—.

37. The method of claim 31, wherein the benzotriazole has a formula of 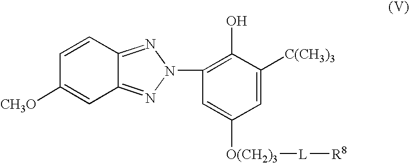
wherein L is —Si(CH₃)₂—.

38. The method of claim 30, wherein the benzotriazole has a formula of 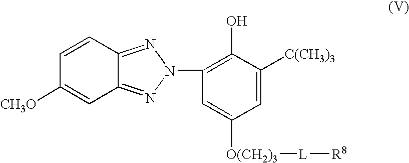
wherein L is a linking group consisting of carbon, hydrogen, and oxygen having from 3 to 6 carbon atoms,; and R⁸ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof;
and the violet-light absorber has a formula of 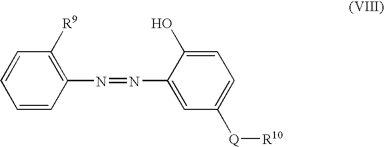
wherein Q is a linking group having from 1 to, and including, 20 carbon atoms and one or more atoms selected from the group consisting of hydrogen, oxygen, nitrogen, halogen, silicon, and combinations thereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.

39. The method of claim 31, wherein the benzotriazole has a formula of 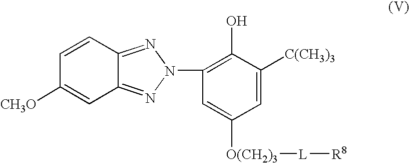
wherein L is a linking group consisting of carbon, hydrogen, and oxygen having from 3 to 6 carbon atoms; and R⁸ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof;
and the violet-light absorber has a formula of 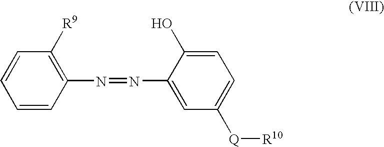
wherein Q is a linking group having from 1 to, and including, 20 carbon atoms and one or more atoms selected from the group consisting of hydrogen, oxygen, nitrogen, halogen silicon, and combinations thereof; R⁹ is selected from the group consisting of unsubstituted and substituted lower alkyl, unsubstituted and substituted lower alkoxy, and halogen; and R¹⁰ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, styryl, and combinations thereof.
